(19) United States
(12) Patent Application Publication
(10) Pub. No.: US 2008/0266877 A1
(43) Pub. Date: Oct. 30, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/845,793

(22) Filed: Aug. 28, 2007

(30) Foreign Application Priority Data
Apr. 27, 2007 (CN) 200710200529.8

(51) Int. Cl. G02B 5/02; F21V 13/04

(52) U.S. Cl. 362/309; 362/333

(57) ABSTRACT

An exemplary optical plate includes at least one transparent plate unit. The transparent plate unit includes a light output surface, a bottom surface, a plurality of elongated V-shaped protrusions, a plurality of spherical depressions, and a lamp-receiving portion. The light output surface is opposite to the bottom surface. The spherical depressions are formed in the light output surface. The elongated V-shaped protrusions are formed on the bottom surface. The lamp-receiving portion is defined in the bottom surface. A backlight module using the present optical plate is also provided.

### CROSS-REFERENCE TO RELATED APPLICATIONS

This application is related to thirteen copending U.S. patent applications, which are: applications Ser. No. 11/835,425, Ser. No. 11/835,426, Ser. No. 11/835,427, Ser. No. 11/835,428, Ser. No. 11/835,429, Ser. No. 11/835,430, and Ser. No. 11/835,431, filed on Aug. 8, 2007; application Ser. No. 11/836,799, filed on Aug. 10, 2007; application Ser. No. 11/842,170, filed on Aug. 21, 2007; applicants Ser. No. 11/843,669, and Ser. No. 11/843,670, filed on Aug. 23, 2007; applications serial No. [to be advised], Attorney Docket No. US14377 and US 14386, and all entitled “OPTICAL PLATE AND BACKLIGHT MODULE USING THE SAME”; In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

In a liquid crystal display device, liquid crystal is a substance that does not itself illuminate light. Instead, the liquid crystal relies on light received from a light source to display data images. In the case of a typical liquid crystal display device, a backlight module powered by electricity supplies the needed light.

FIG. 9 represents a typical direct type backlight module 100. The backlight module 100 includes a housing 101, a light reflective plate 102, a light diffusion plate 103, a prism sheet 104, and a plurality of light emitting diodes 105 (hereinafter called LEDs). The housing 101 includes a rectangular base 1011 and four sidewalls 1013 extending around a periphery of the base 1011. The base 1011 and the four sidewalls 1013 cooperatively define a chamber 1017. Each LED 105 includes a base portion 1053 and a light-emitting portion 1051 disposed on the base portion 1053. The LEDs 105 are electrically connected to a printed circuit board (not labeled), and the printed circuit board is fixed to the base 1011 of the housing 101. The light reflective plate 102 is disposed on the LEDs 105 in the chamber 1017. The light reflective plate 102 defines a plurality of through holes (not labeled) that allows the light-emitting portions 1051 of the LEDs 105 to pass through and to emit light to be transmitted to the light diffusion plate 103. The light diffusion plate 103 and the prism sheet 104 are stacked in that order on the chamber 1017. Light emitted from the LEDs 105 is substantially reflected by the light reflective sheet 102 to enter the light diffusion plate 103, and diffused uniformly in the light diffusion plate 103, and finally surface light is outputed from the prism sheet 104.

Generally, a plurality of dark areas may occur because of the reduced intensity of light between adjacent LEDs 105. In the backlight module 100, each LED 105 further includes a reflective sheet 106 disposed on the top of the light-emitting portion 1051, configured for decreasing the brightness of a portion of the backlight module 100 above the LED 105. As a result, the brightness of the backlight module 100 is still not uniform. One method of enhancing the uniformity of brightness of the backlight module 100 is to increase the space between the light diffusion plate 103 and the LEDs 105. This increase in space tends to eliminate potential dark areas. However, increasing the space between the diffusion plate 103 and the LEDs 105 will also increase the thickness of the backlight module and further the overall intensity of the output light rays is reduced.

What is needed, therefore, is a new optical plate and a backlight module using the optical plate that can overcome the above-mentioned shortcomings.

### SUMMARY

An optical plate according to a preferred embodiment includes at least one transparent plate unit. The transparent plate unit includes a first surface, a second surface, a plurality of elongated V-shaped protrusions, a plurality of spherical depressions and a lamp-receiving portion. The second surface is opposite to the first surface. The elongated V-shaped protrusions are formed on the first surface. The spherical depressions are formed in the second surface. The lamp-receiving portion is defined in at least one of the first surface and the second surface.

A backlight module according to a preferred embodiment includes a housing, one or more point light source, one or more reflective member, an optical plate, and a light diffusion plate. The housing includes a base and a plurality of sidewalls extending around a periphery of the base, the base and the sidewalls cooperatively forming an opening. The point light source is disposed on the base. Each point light source has a light-emitting portion and each reflective member is disposed above the top portion of the light-emitting portion. The same optical plate as described in the previous paragraph is employed in this embodiment. The light-emitting portion of the point light source is inserted in the lamp receiving portion of the optical plate correspondingly. The light diffusion plate is disposed on the housing over the opening.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout several views, and all the views are schematic.

FIG. 1 is a side cross-sectional view of a backlight module using an optical plate according to a first preferred embodiment of the present invention.

FIG. 2 is an isometric view of the optical plate of FIG. 1.

FIG. 3 is similar to FIG. 2, but viewed from another aspect.

FIG. 4 is a side cross-sectional view taken along line IV-IV of FIG. 2.

FIG. 5 is a side cross-sectional view of an optical plate according to a second preferred embodiment of the present invention.

FIG. 6 is a side cross-sectional view of an optical plate according to a third preferred embodiment of the present invention.

FIG. 7 is a top plane view of an optical plate according to a fourth preferred embodiment of the present invention.

FIG. 8 is an isometric view of an optical plate according to a fifth preferred embodiment of the present invention.

FIG. 9 is a side cross-sectional view of a conventional backlight module.

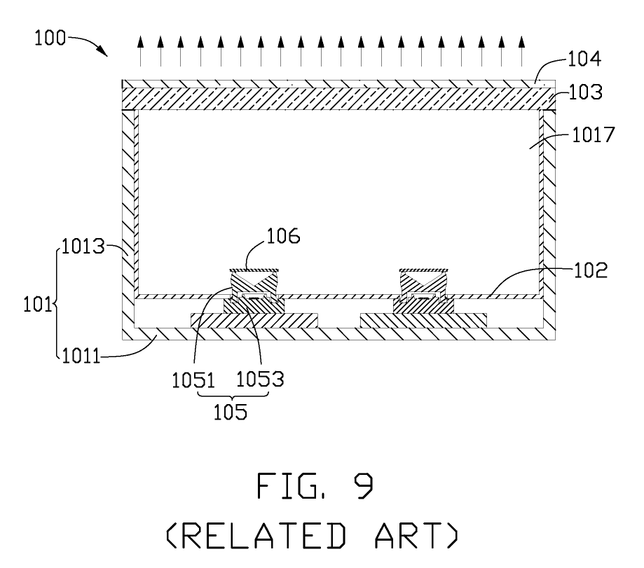

### DETAILED DESCRIPTION OF THE PREFERRED EMBODIMENTS

Reference will now be made to the drawings to describe preferred embodiments of the present optical plate and backlight module, in detail.

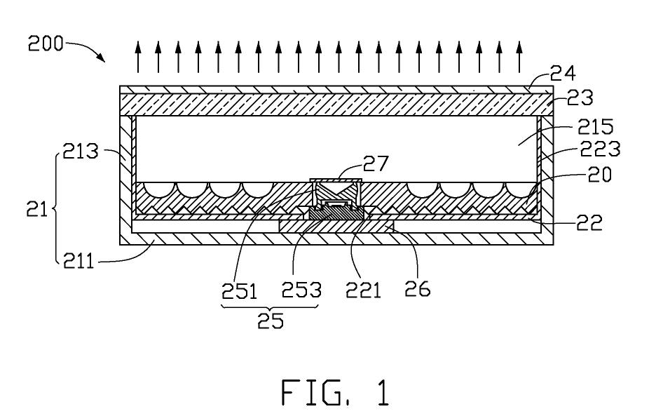

Referring to FIG. 1, a backlight module 200 in accordance with a first preferred embodiment is shown. The backlight module 200 includes a housing 21, a light reflective plate 22, a light diffusion plate 23, a LED 25, a reflective member 27, and an optical plate 20. The housing 21 includes a rectangular base 211 and four sidewalls 213 extending around a periphery of the base 211, the base 211 and the sidewalls 213 cooperatively forming an opening 215. The optical plate 20, the light reflective plate 22, and the LED 25 are received in the housing 21. The light diffusion plate 23 is disposed on the housing 21 over the opening 215.

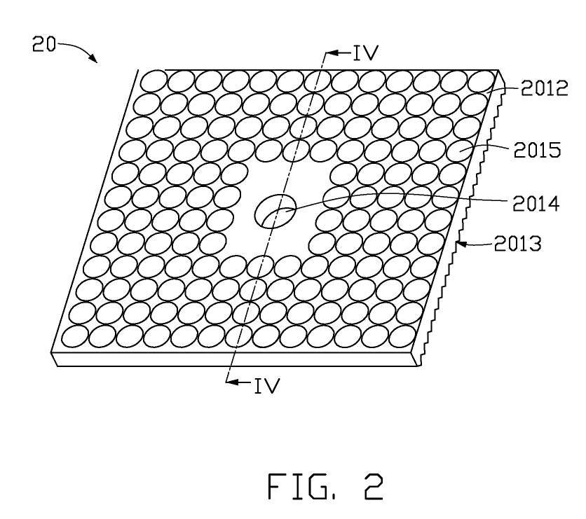

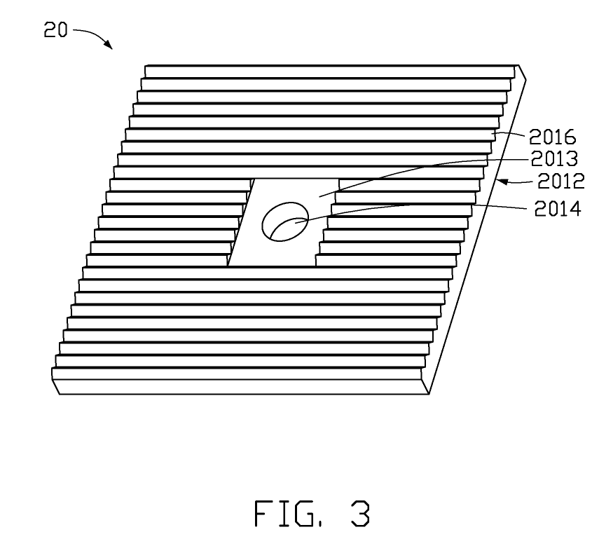

Referring to FIGS. 2 through 4, the optical plate 20 is a transparent plate that can be mounted into the housing 21. The optical plate 20 includes a light output surface 2012 (shown in FIG. 2) and a bottom surface 2013 (shown in FIG. 3) opposite to the light output surface 2012. A plurality of spherical depressions 201 5 are formed in the light output surface 2012. A plurality of elongated V-shaped protrusions 201 6 are formed on the bottom surface 2013. The optical plate 20 further includes a lamp-receiving portion 2014 defined in the bottom surface 2013 at a center of the optical plate 20. In the illustrated embodiment, the lamp-receiving portion 2014 is a through hole that communicates between the light output surface 2012 and the bottom surface 2013. The elongated V-shaped protrusions 2016 are distributed at the bottom surface 2013 except for a square area around the lamp-receiving portion 2014. The elongated V-shaped protrusions 2016 are aligned and extend in a same direction, thus parallel to each other. The spherical depressions 2015 are distributed in a matrix order at the light output surface 2012 except for an area substantially square around the lamp-receiving portion 2014.

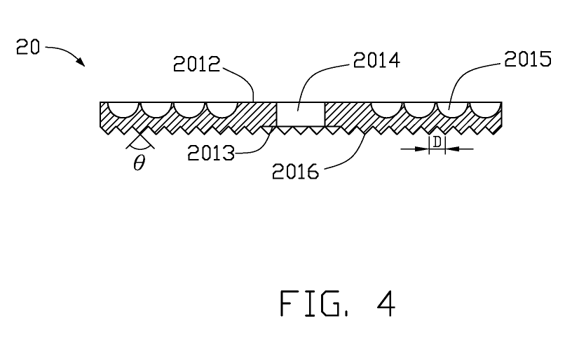

In the illustrated embodiment, a radius defined by each spherical depression 2015 is preferably in a range from about 0.01 millimeters to about 2 millimeters. A maximum depth of each spherical depression 2015 is in a range from about 0.01 millimeters to about 2 millimeters. Also referring to FIG. 4, a pitch D of two adjacent elongated V-shaped protrusions 2016 is configured to be in a range from about 0.025 millimeters to about 2 millimeters. A vertex angle θ of each of the elongated V-shaped protrusions 2016 is configured to be in a range from about 60 degrees to about 120 degrees.

The optical plate 20 can be made from material selected from the group consisting of polycarbonate (PC), polymethyl methacrylate (PMMA), polystyrene (PS), copolymer of methylmethacrylate and styrene (MS), and any suitable combination thereof. A thickness of the optical plate 20 is, preferably, in a range from 0.5 millimeters to about 5 millimeters.

Referring to FIG. 1 again, the LED 25 includes a base portion 253 and a light-emitting portion 251 disposed on the base portion 253. The LED 25 is electrically connected to a printed circuit board 26 that is fixed to the base 211 of the housing 21. In the illustrated embodiment, the reflective member 27 is a light reflective sheet that is disposed above the top of the light-emitting portion 251.

The light-emitting portion 251 of the LED 25 is inserted into the lamp-receiving portion 2014 of the optical plate 20 with the light output surface 2012 of the optical plate 20 facing the light diffusion plate 23. The light reflective plate 22 defines a through hole 221 corresponding to the lamp-receiving portion 2014 of the optical plate 20. The light reflective plate 22 is disposed on the bottom surface 2013 of the optical plate 20 with the light-emitting portion 251 of the LED 25 passing through the through the hole. The base portion 253 of the LED 25 supports the light reflective plate 22 and the optical plate 20 together.

In use, light emitted from the light-emitting portion 251 of the LED 25 enters the optical plate 20 via inner surfaces of the lamp-receiving portion 2014. A significant amount of the light is transmitted through the optical plate 20. Since the surfaces of the elongated V-shaped protrusions 2016 are slanted, incident light that may have been internally reflected on a flat surface, are refracted at the slanted surfaces of the elongated V-shaped protrusions 2016. As a result, a great amount of light is able to be outputted, from the light output surface 2012, faster.

In addition, the spherical depressions 2015 can condense and collimate light exiting the light output surface 2012, thereby improving a light illumination brightness. Furthermore, because the LED 25 is positioned in the lamp-receiving portion 2014, light exits the light output surface 2012 uniformly. Light exiting the optical plate 20 can be further substantially mixed in a chamber between the optical plate 20 and the light diffusion plate 23, and before passing through the light diffusion plate 23 as uniform surface light. A distance from the LED 25 to the light diffusion plate 23 may be configured to be very small, with little or no potential risk of having dark areas on the portion of the backlight module 200 directly above the LED 25. Accordingly, the backlight module 200 can have a thin configuration while still providing good, uniform optical performance.

It should be pointed out that, the light reflective plate 22 can be omitted. In an alternative embodiment, a high reflectivity film can be deposited on inner surface of the base 211 and the sidewalls 213 of the housing 21. In other alternative embodiment, the housing 21 is made of metal materials, and has high reflectivity inner surfaces.

It is to be understood that, in order to improve brightness of the backlight module 200 within a specific range of viewing angles, the backlight module 200 can further include a prism sheet 24 disposed on the light diffusion plate 23. In addition, in order to improve light energy utilization rate of the backlight module 200, the light reflective plate 22 can further include four reflective sidewalls 223 extending around a periphery and in contact with the sidewalls 213 of the housing 21.

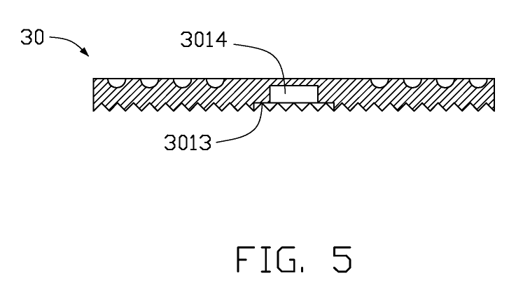

Referring to FIG. 5, an optical plate 30 in accordance with a second preferred embodiment is shown. The optical plate 30 is similar in principle to the optical plate 20, except that a lamp-receiving portion 3014 of the optical plate 30 is a blind hole defined in a bottom surface 3013. It should be pointed out that, a reflective layer can be deposited on a center of the optical plate 30 above the lamp-receiving portion 3014. Due to the reflective layer, a backlight module without an extra reflective member can be assembled.

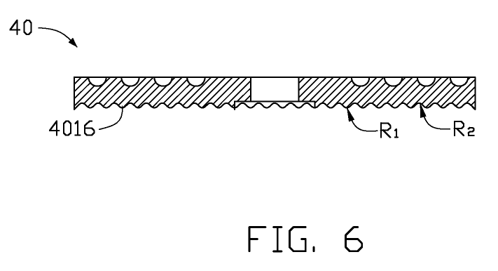

Referring to FIG. 6, an optical plate 40 in accordance with a third preferred embodiment is shown. The optical plate 40 is similar in principle to the optical plate 20, except that a top edge of each elongated V-shaped protrusion 4016, or a bottom edge defined by the boundary formed by two adjacent elongated V-shaped protrusions 4016 are rounded. The curvature of this rounded surface is defined by a sphere of radius R. The radius R₁ of the rounded top edge and the radius R₂ of the rounded bottom edge are equal to or less than 1.1 millimeters, and greater than zero.

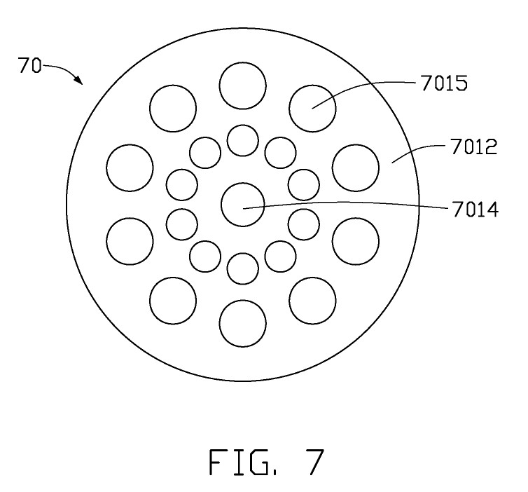

Referring to FIG. 7, an optical plate 70 in accordance with a fourth preferred embodiment is shown. The optical plate 70 is similar in principle to the optical plate 20, except that a plurality of spherical depressions 7015 are formed in a light output surface 7012 surrounding a lamp-receiving portion 7014 and a diameter of each spherical depression 7015 increases along a receding direction from the lamp-receiving portion 7014. In the illustrated embodiment, the further distance from a spherical depression 7015 to the lamp-receiving portion 7014, the more light can be refracted out from the light output surface 7012. Thus, a more uniform optical performance is achieved. In other alternative embodiment, if the diameters of the spherical depressions 7015 are identical to each other, the same optical performance can be achieved by adjusting a density of spherical depressions 7015 at varying distances. It can be understood that spherical depressions can be distributed symmetrically with respect to a lamp-received portion at a light output surface or randomly distributed at a light output surface.

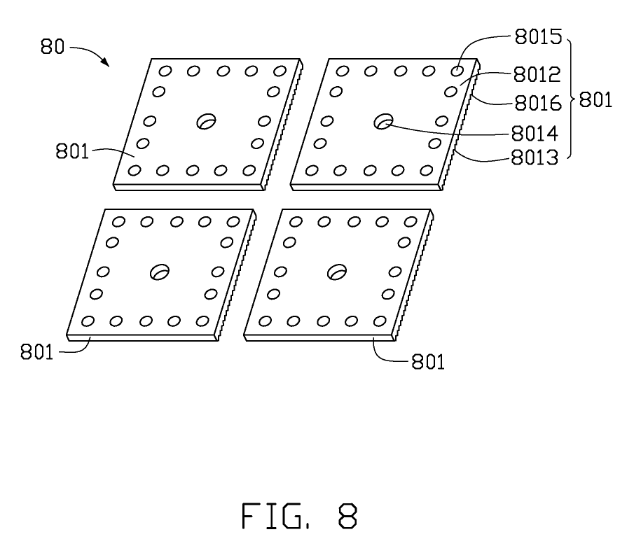

Referring to FIG. 8, another combined optical plate 80 in accordance with a sixth preferred embodiment is shown. The combined optical plate 80 includes four transparent plate units 801 that can be combined with together. Each transparent plate unit 801 is similar in principle to the optical plate 20. Either spherical depressions 8015 formed in light output surface 8012 or elongated V-shaped protrusions 8016 formed on bottom surface 8013, are similar as those of the optical plate 20. In use, a plurality of LEDs and the combined optical plate 80 can be mounted into a housing to form a larger sized backlight module.

It should be noted that, the backlight module 200 is not limited to be configured with the optical plate 20 positioned in the housing 21 having the light output surface 2012 facing the light diffusion plate 23, but can also be configured with the optical plate 20 positioned in the housing 21 having the bottom surface 2013 facing the light diffusion plate 23. That is, the elongated V-shaped protrusions 2016 are formed on a first surface of the optical plate 20, and the spherical depressions 2015 are formed in a second surface of the optical plate 20. The first surface is selected from one of the light output surface 2012 and the bottom surface 2013, and the second surface is selected from the other one of the light output surface 2012 and the bottom surface 2013. However, if a lamp-receiving portion is a blind hole, a surface where the blind hole is defined must be a bottom surface and the other surface must be a light output surface.

In the backlight module 200, a plurality of red, green, and blue colored LEDs can be inserted into the lamp-receiving portion 2014 of the optical plate 20, such that a blended white surface light can be obtained. It is to be understood that other kinds of point light source, such as field emission lamps and so on, can replace the LED 25 in above embodiments.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate comprising:
at least one transparent plate unit having:
a first surface;
a second surface opposite to the first surface;
a plurality of elongated V-shaped protrusions formed on the first surface;
a plurality of spherical depressions formed in the second surface; and
at least a lamp-receiving portion defined in at least one of the first surface and the second surface.

2. The optical plate according to claim 1, wherein the elongated V-shaped protrusions parallel to each other.

3. The optical plate according to claim 1, wherein a pitch of two adjacent elongated V-shaped protrusions is configured to be in a range from about 0.025 millimeters to about 2 millimeters.

4. The optical plate according to claim 1, wherein a vertex angle of each of the elongated V-shaped protrusions is configured to be in a range from about 60 degrees to about 120 degrees.

5. The optical plate according to claim 1, wherein at least one of top edge of each elongated V-shaped protrusion and bottom edge defined by the boundary formed by the bases of two adjacent elongated V-shaped protrusions, is rounded.

6. The optical plate according to claim 1, wherein the spherical depressions are formed in the second surface in a matrix order except for the lamp-received portion.

7. The optical plate according to claim 1, a radius defined by each spherical depression is preferably in a range from about 0.01 millimeters to about 2 millimeters, a maximum depth of each spherical depression is in a range from about 0.01 millimeters to about 2 millimeters.

8. The optical plate according to claim 1, a diameter of each spherical depression increases along a receding direction from the lamp-receiving portion.

9. The optical plate according to claim 1, wherein the lamp-receiving portion is selected from one of blind hole and through hole communicating between the first surface and the second surface.

10. The optical plate according to claim 1, wherein the optical plate includes a plurality of the transparent plate units, the transparent plate units being tightly combined with each other.

11. A backlight module comprising:
a housing having a base and a plurality of sidewalls extending around a periphery of the base, the base and the sidewalls cooperatively forming an opening;
at least one point light source disposed on the base, each point light source having a light-emitting portion;
at least one reflective member is positioned above the top of the light-emitting portion;
an optical plate positioned in the housing, the optical plate including at least one transparent plate unit having:
a first surface;
a second surface opposite to the first surface;
a plurality of elongated V-shaped protrusions formed on the first surface;
a plurality of spherical depressions formed in the second surface; and
a lamp-receiving portion defined in at least one of the first surface and the second surface, wherein the light-emitting portion of the at least one point light source is inserted in the lamp receiving portion; and
a light diffusion plate disposed on the housing over the opening.

12. The backlight module according to claim 11, further comprising a light reflective plate defining a through hole therein, the light reflective plate being disposed on the bottom surface of the optical plate, and the light emitting potion of the point light source passing through the through hole of light reflective plate correspondingly.

13. The backlight module according to claim 12, wherein the light reflective plate further comprises a plurality of reflective sidewalls extending around a periphery thereof and contacting with the sidewalls of the housing.

14. The backlight module according to claim 11, wherein the housing is made of metal materials, and has high reflectivity inner surfaces.

15. The backlight module according to claim 11, further comprising a prism sheet disposed on the light diffusion plate.

16. The backlight module according to claim 11, wherein at least one of a top edge of each elongated V-shaped protrusion and bottom edge defined by the boundary formed by the bases of two adjacent elongated V-shaped protrusions, is rounded.

17. The backlight module according to claim 11, wherein the lamp-receiving portion is selected from one of blind hole and through hole communicating with the first surface and the second surface.
